(19) United States
(12) Patent Application Publication
(10) Pub. No.: US 2011/0232338 A1
(43) Pub. Date: Sep. 29, 2011

(54) Pick resistant handcuffs having central rail

(76) Inventors: Wen-Sheng Huang, Ta-Li City (TW); Charles E. Thompson, Riverside, IL (US)

(21) Appl. No.: 12/836,537

(22) Filed: Jul. 14, 2010

(30) Foreign Application Priority Data
Jul. 15, 2009 (TW) 098212921

(51) Int. Cl. E05B 75/00

(52) U.S. Cl. 70/16

(57) ABSTRACT

Pick-resistant handcuffs having two fixed, arc-shaped hooks and one pivotable, arc-shaped hook. The two fixed ring hooks engage each other to form an accommodation chamber for receiving the pivoting hook penetrating into an open side of the accommodation chamber. Central channels are cut in the teeth outer periphery and accommodate a stop projecting part between the lateral edges of the teeth that inhibits unlocking the stop members of the ratchet attached to the two fixed hooks. Elastic members biased toward the teeth are disposed on either side of the stop projecting part act independently to provide ratchet stops to each tooth edge, and the stop projecting portion blocks insertion of a pick and unlock both of the two ratchets simultaneously.

### EXPLANATION OF THE UTILITY MODEL

1. Technical Field of the Utility Model

The present design pertains to a structural modification to handcuffs, especially, a handcuff structure that has a good locking effect and can effectively prevent unlocking by improper means or articles other than the key.

2. Prior Art

As shown in FIG. 1, the conventional handcuff structure has a chain D (or a steel cord or other similar connection member) that connects two handcuff main bodies C (it is also possible to connect a single handcuff main body C at a fixed position). Each handcuff body A is comprised of two fixed, arc-shaped hooks 1, 10 and a movable ring hook 20 that rotate relative to each other about a pivot 100. The two fixed ring hooks 1, 10 are engaged with each other at the other end. There is an accommodation chamber 11. A horizontal side hole 13 connected to the outside is provided on said accommodation chamber 11 at the end adjacent to fixed ring hooks 1, 10. A connected key recessed part 12 is provided at the other end of said accommodation chamber 11. Said key recessed part 12 can be connected to the outside via a key hole 121. A plurality of projecting teeth 21 are provided on the outer periphery at the other free end of said movable ring hook 20. One end of a locking member 3 is pivoted in accommodation chamber 11 on the side away from key recessed part 12. The other end of said locking member 3 has a side projecting part 31 that can stick into said key recessed part 12. A projecting part 32 that extends upwards is provided on the side of said side projecting part 31. A plurality of lock projecting teeth 33 are provided at the other (free) end of locking member 3 corresponding to the open side of accommodation chamber 11. A stop block 5 is provided on the top side in accommodation chamber 11. A side edge 51 extending toward key recessed part 12 is provided at its one end. An abutting part 52 extending downwards is provided on the side of said side edge 51. A plurality of alignment recessed parts 53 are provided on the side of said abutting part 52. A V-shaped elastic member 4 is provided between locking member 3 and stop block 5. One side of the elastic member is abutted against the top edge of said locking member 3, while the other side has at least one bent projecting part 41 to fit in the alignment recessed part 53 of stop block 5. Also, the elastic abutting of said elastic member 4 can make locking member 3 maintain the outward elasticity of its lock projecting teeth 33 from accommodation chamber 11. During use, when the free end of said movable ring hook 20 sticks into accommodation chamber 11, its projecting teeth 21 can be engaged with the lock projecting teeth 33 of locking member 3 to achieve locking. At that time, the arms and legs (usually, wrists) of a person can fit in the spaces defined between fixed ring hooks 1, 10 and movable ring hook 20 to restrain the person's movement. As shown in FIG. 2, if a thin push rod penetrates through side hole 13 from outside, it can push stop block 5 and make it slide. The abutting part 52 of stop block 5 can move to the right to the position where it abuts against the projecting part 32 of locking member 3 to achieve a reinforced locking state of the locking member 3 that is more difficult to unlock by illegal means. If it is necessary to unlock handcuff main body C under normal circumstances, a key can be inserted into key recessed part 12 from key hole 121. When the key is first turned counterclockwise, the projecting abutting part at the end of the key pushes stop block 5 to move in the opposite direction (to the left) to release the abutting state of its abutting part 52 against projecting part 32 on the top. Then, the projecting abutting part of the key is turned clockwise so that the projecting abutting part can push the side projecting part 31 of locking member 3 upwards. As a result, locking member 3 pivots and lock projecting teeth 33 are disengaged from the projecting teeth 21 of movable ring hook 20 (and pressing elastic member 4 at the same time) so that movable ring hook 20 can pivot in the opposite direction, and its free end is disengaged in accommodation chamber 11 to release the aforementioned locking state. However, since the aforementioned locking structure and theory are relatively simple and the shape of the key has no complicated variations, anybody can unlock the handcuffs with a thin wire having a hook instead of the key. Therefore, the locking effect is extremely poor in practical application, which always causes troubles to the user.

Therefore, the structure shown in FIG. 3 is disclosed. The handcuff main body B is based on the structure shown in FIG. 1. It has the same fixed ring hooks 1, 10, movable ring hook 20, and other basic structures. The only difference is that locking member 3, elastic element 4, and stop block 5 have locking member 30, elastic member 40, and stop block 50 having exactly the same structures provided on their side, respectively. Two groups of independent locking mechanisms are formed by said locking member 3, elastic element 4, and stop block 5 as well as locking member 30, elastic member 40, and stop block 50 to lock said movable hook ring 20. When a thin wire having a hook is inserted and turned, it can only unlock one group of the locking mechanism, that is, locking member 3, and stop block 5 (or locking member 30, and stop block 50), while the locking member 30, and stop block 50 (or locking member 3, and stop block 5) are still in the locking state. In this way, it is possible to effectively prevent the handcuffs from being unlocked by any non-key, hook-shaped article. However, relatively big spaces 14, 141 (as shown in FIG. 4) are usually left between said movable ring hook 20 and the front, rear sides of accommodation chamber 11 so that the projecting teeth 21 of movable ring hook 20 can easily penetrate into (or pass through) the open side of accommodation chamber 11 (to engage with the lock projecting teeth 33 of locking member 3). Therefore, with adequate force, anybody can stick a narrow body 7 into spaces 14, 141. As a result, said narrow body is inserted between the projecting teeth 21 of movable ring hook 20 and the lock projecting teeth 33 of locking member 3 and disengage them from each other to unlock the handcuffs. This is a serious problem in application.

In order to solve the aforementioned problems of the conventional handcuffs, the present designer has conducted extensive research. The present design was reached as a result of this research.

### CONTENT OF THE UTILITY MODEL

The main objective of the present design is to provide a structural modification to handcuffs, which can prevent a non-key tool from being inserted into the key hole to unlock the cuffs and can prevent a narrow body or other improper means from being inserted into the space between the movable ring hook and the accommodation chamber to unlock the cuffs. In this way, it is possible to increase the difficulty of illegal unlocking and improve the locking effect.

In order to realize the aforementioned objective and effect, the technical means adopted by the present design includes: two fixed, arc-shaped hooks, the two fixed ring hooks are engaged with each other at the other end to form an accommodation chamber that opens inside, and a pair of key holes connecting to the outside are provided in the middle part on one side of the accommodation chamber; a movable, arc-shaped hook with one end pivoted between the two fixed ring hooks at the end away from the accommodation chamber, a plurality of projecting teeth and a middle channel that penetrates through each projecting tooth are provided on the outer periphery at the other end of the movable ring hook, and the plurality of projecting teeth can penetrate into the open side of the accommodation chamber as the movable ring hook pivots; a plurality of identical locking members provided in parallel with each other, one end of each locking member is jointly pivoted inside the accommodation chamber facing one side of the fixed ring hooks, while a side projecting part that can extend to the part corresponding to the key hole is provided at the other end, and a plurality of lock projecting teeth are provided on the side of each locking member corresponding to the open side of the accommodation chamber; at least one spacer provided between every two locking members with one end jointly pivoted with the locking members in the accommodation chamber, a stop projecting part corresponding to the lock projecting teeth of the locking member is provided at the other end of the spacer; at least one elastic member provided between each locking member on the side opposite to the side having the lock projecting teeth and the inner side of the accommodation chamber, the elastic member can abut against the locking member so that the lock projecting teeth thereof can keep an outward elasticity in order to fit between the plurality of projecting teeth of the movable ring hook, and the spacer can be inserted into the middle channel.

The detailed structure, application theory, effects and functions of the present design can be fully understood based on the following explanation with reference to the attached figures.

### EMBODIMENT

As shown in FIG. 5, it is clear that the structure of the handcuff main body A of the present design mainly includes: two fixed, arc-shaped hooks 1, 10 and one movable, arc-shaped hook 2, at least two identical locking members 3, 30, at least one elastic member 400, at least two stop blocks 5, 50, and at least one spacer 6. One end of said movable ring hook 2 is pivoted between one end of two fixed ring hooks 1, 10 via a pivot 100. The two fixed ring hooks 1, 10 are engaged with each other at the other end. Also, there is an accommodation chamber 11 that is open at the inside. A horizontal side hole 13 that connects to the outside is provided at one end of accommodation chamber 11 adjacent to fixed ring hooks 1, 10. A connected key recessed part 12 is provided on the side of the other end of accommodation chamber 11. Said key recessed part 12 can be connected to the outside through a key hole 121. A plurality of projecting teeth 21 are provided on the outer periphery at the other free end of movable ring hook 2. There is a middle channel 22 that penetrates through each projecting tooth 21 in the longitudinal direction. Locking members 3, 30 are jointly pivoted at one end in accommodation chamber 11 on the side away from key recessed part 12. Projecting parts 31, 301 that can stick into key recessed part 12 are provided at the other end of locking members 3, 30, respectively. A plurality of lock projecting teeth 33, 303 are provided on the side of said projecting parts 31, 301 corresponding to the open side of accommodation chamber 11. Projecting parts 32, 302 that extend upwards are provided on the opposite side of said lock projecting teeth 33, 303, respectively. Spacer 6 is provided between said two locking members 3, 30 with one end jointly pivoted along with locking members 3, 30 in accommodation chamber 11. Side projecting part 61, top projecting part 62, and stop projecting part 63 are provided at the other end of spacer 6 correspond to the side projecting part 31, top projecting part 32, and lock projecting teeth 33 of locking member 3, respectively. Stop blocks 5, 50 are provided in accommodation chamber 11 with one end jointly set on the side corresponding to side hole 13. Side edges 51, 501 that extend toward key recessed part 12 are provided at the other end, respectively. Abutting parts 52, 502 are provided beside side edges 51, 501 corresponding to the open side of accommodation chamber 11, respectively. A plurality of alignment recessed parts 53, 503 are provided beside said abutting parts 52, 502. Elastic member 400 has a V shape and is provided between locking members 3, 30 and stop blocks 5, 50. Two branched edge sides 42, 421 are provided on its one side to abut against the top side edges of the two locking members 3, 30, respectively. At least one bent projecting part 41 is provided on the other side to fit in the alignment recessed parts 53, 503 of stop blocks 5, 50. With the aid of the elastic support by V-shaped elastic member 400, said two locking members 3, can maintain its outward elasticity from accommodation chamber 11 through their lock projecting teeth 33, 303.

As shown in FIGS. 6-8, in practical application, when the free end of the movable ring hook 2 is inserted into the open side of accommodation chamber 11, the projecting teeth 21 can be engaged with the lock projecting teeth 33, 303 of locking members 3, 30 at the same time to lock the handcuffs. The stop projecting part 63 of spacer 6 can also stick into the middle channel 22 of movable ring hook 2 (there will be no interference between them since the extending direction of middle channel 22 is the same as the extending/contracting direction of movable ring hook 2). At that time, said two fixed ring hooks 1, 10 and movable ring hook 20 can define a locked space. If somebody tries to stick a narrow body 7 into the spaces 14, 141 between movable ring hook 2 and the front, rear sides of accommodation chamber 11, said narrow body 7 will be blocked by stop projecting part 63 and cannot be inserted into the space. Therefore, a narrow body 7 cannot be used to disengage lock projecting teeth 33, 303 from the plurality of projecting teeth 21. In this way, it is possible to fully solve the problem of the conventional handcuffs, that is, narrow body 7 can be easily inserted between lock projecting teeth 33, 303 and the plurality of projecting teeth 21 in order to disengage them from each other. The present design can also effectively prevent illegal unlocking by inserting a thin wire with a hook into key hole 121.

According to the present design, a thin push rod can penetrate from outside through side hole 13 to push two stop blocks 5, 50 and make them slide at the same time. The abutting parts 52, 502 of stop blocks 5, 50 can move to the right to the positions where they abut against the top projecting parts 32, 302 of locking members 3, 30 so that locking members 3, 30 form a reinforced locking state that is more difficult to unlock by illegal means. To unlock the handcuffs by normal means, the key is inserted into key recessed part 12 from key hole 121 and is first turned counterclockwise so that the projecting part at the end of the key can push the side edges 51, 501 of two stop blocks 5, 50 at the same time to make them move in the opposite direction (to the left). At that time, the two abutting parts 52, 502 are released from the abutting state against top projecting parts 32, 302. Then, the key is turned clockwise to make the projecting part push the side projecting parts 31, 301 of locking members 3, 30 and the side projecting part 61 of spacer 6 upwards at the same time. As a result, locking members 3, 30 pivot synchronously with spacer 6, and lock projecting teeth 33, 303 and stop projecting part 63 are also disengaged from the projecting teeth 21, middle channel 22 of movable ring hook 2 so that movable ring hook 2 can pivot in the opposite direction. The free end of the movable ring hook is disengaged in accommodation chamber 11 to release said locking state.

As described above, the structural modification to handcuffs disclosed in the present design can indeed increase the difficulty of unlocking the handcuffs by improper means and can improve the locking effect. It truly possesses industrial applicability, novelty, and inventiveness.

The example described above is only one preferable application example of the present design and should not limit the embodiment scope of the present design. In other words, any equivalent variation and decoration made within the scope of the claims of the present deign is covered by the patent scope of the present design.

### BRIEF DESCRIPTION OF THE FIGURES

FIG. 1 is the structural exploded diagram of one type of conventional handcuffs.

FIG. 2 is a cross-sectional view illustrating the reinforced locking state of the handcuffs shown in FIG. 1.

FIG. 3 is the structural exploded diagram of another type of conventional handcuffs.

FIG. 4 is a diagram illustrating the operation of unlocking the handcuffs shown in FIG. 3 with an improper means.

FIG. 5 is the structural exploded diagram of the present design.

FIG. 6 is a diagram illustrating the engagement state between the projecting teeth and the lock projecting teeth in the locking state of the present design.

FIG. 7 is a diagram illustrating the state when the spacer is inserted into the middle channel in the locking state of the present design.

FIG. 8 is a diagram illustrating the state when somebody tries to unlock the handcuffs of the present design by an improper means.

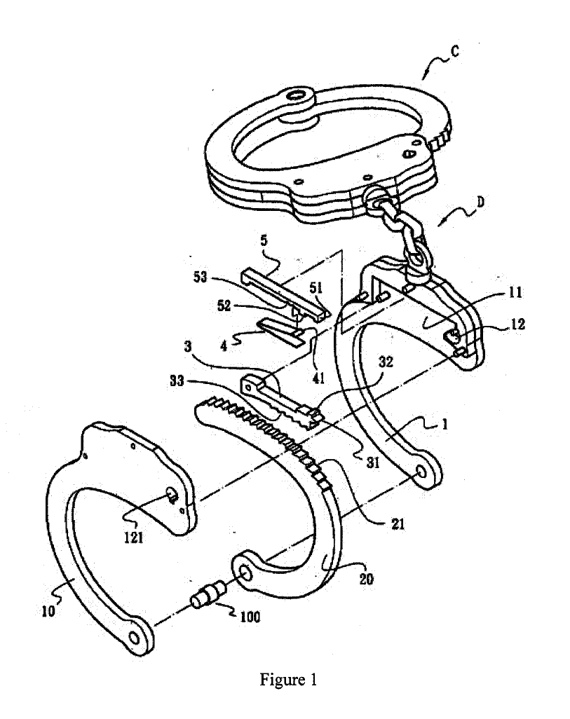

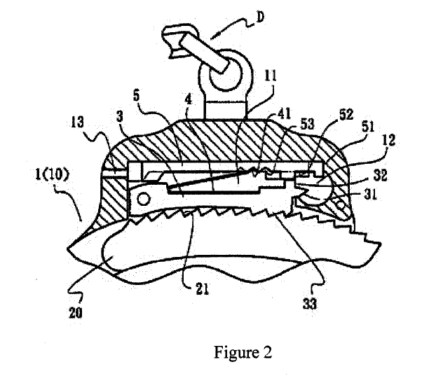

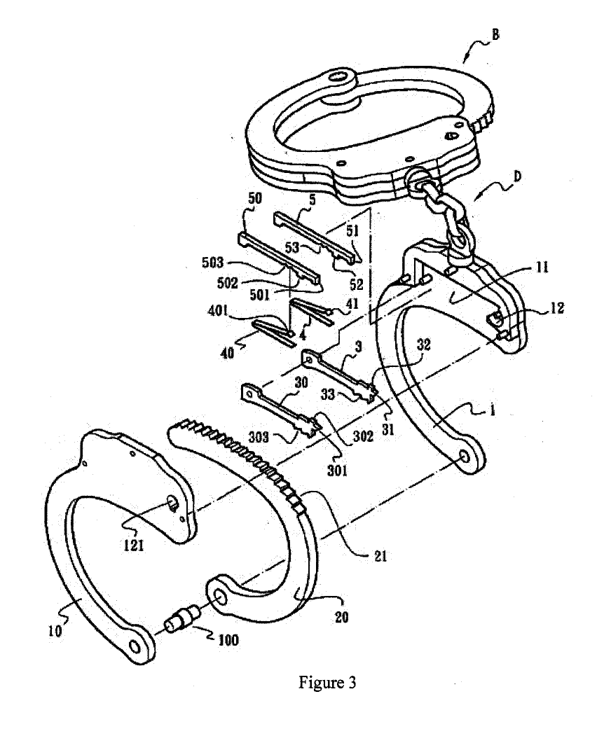

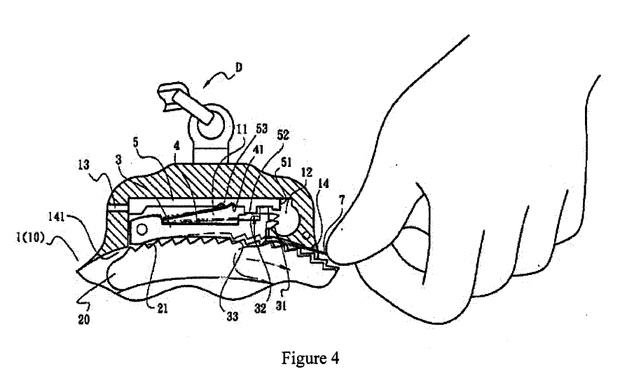

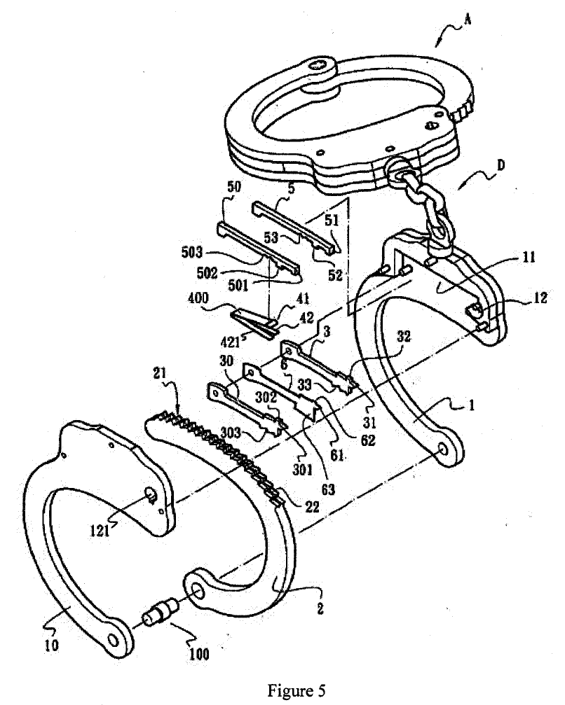

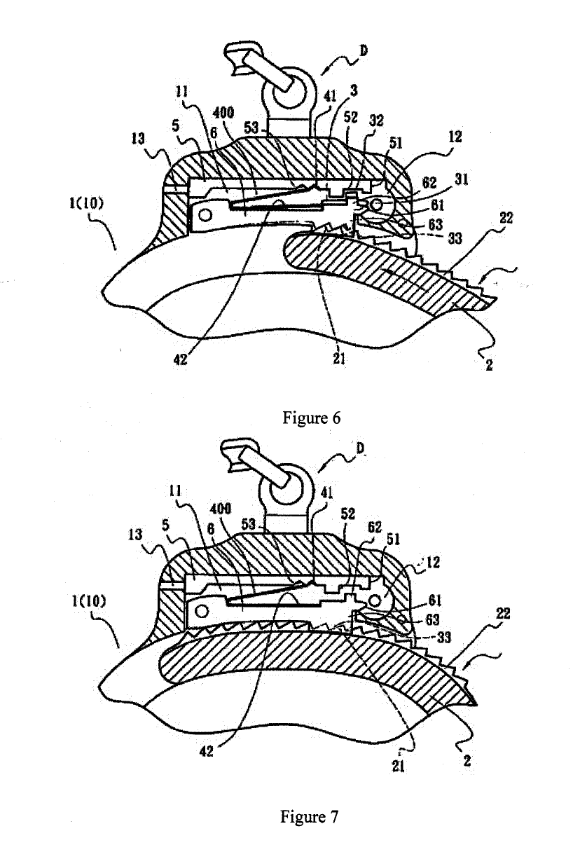

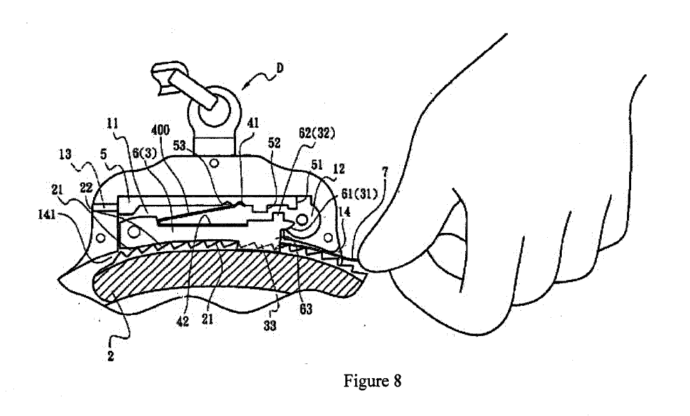

### EXPLANATION OF THE SYMBOLS OF THE MAIN PARTS

A, B, C . . . Main body of handcuffs
D . . . Chain
1, 10 . . . Fixed ring hooks
100 . . . Pivot
11 . . . Accommodation chamber
12 . . . Key recessed part
121 . . . Key hole
13 . . . Side hole
14, 141 . . . Space
2, 20 . . . Movable ring hook
21 . . . Projecting teeth
22 . . . Middle channel
3, 30 . . . Locking member
31, 301, 61 . . . Side projecting part
32, 302, 62 . . . Top projecting part
33, 303 . . . Lock projecting teeth
4, 40, 400 . . . Elastic member
41, 401 . . . Bent projecting parts
42, 421 . . . Edge side
5, 50 . . . Stop block
51, 501 . . . Side edge
52, 502 . . . Abutting part
53, 503 . . . . Alignment recessed part
6 . . . Spacer
63 . . . Stop projecting part
7 . . . Narrow body

1. Handcuffs comprising:
two fixed, arc-shaped hooks, the two fixed ring hooks are engaged with each other at opposed ends to form an accommodation chamber that is open at the inside to define a cavity, and a pair of key holes connecting to the outside are provided in the middle part on one side of the accommodation chamber;
a movable, arc-shaped hook with one opposed end being connected to that pivoted between the two fixed ring hooks at the opposed end disposed away from the accommodation chamber, a plurality of projecting teeth and a middle channel penetrating through each projecting tooth are provided on the outer periphery at the other end of the movable ring hook, and the plurality of projecting teeth capable of penetrating into the accommodation chamber cavity as the movable ring hook pivots;
a plurality of identical locking members provided in parallel with each other, one end of each locking member is jointly pivoted inside the accommodation chamber facing one side of the fixed ring hooks, while a side projecting part that can extend to the part corresponding to the key hole is provided at the other end, and a plurality of lock projecting teeth are provided on the side of each locking member corresponding to the open side of the accommodation chamber;
at least one spacer provided between every two locking members with one end jointly pivoted with the locking members in the accommodation chamber, a stop projecting part corresponding to the lock projecting teeth of the locking member is provided at the other end of the spacer; and
at least one elastic member provided between each locking member on the side opposite to the side having the lock projecting teeth and the inner side of the accommodation chamber, the elastic member can abut against the locking member so that the lock projecting teeth thereof can maintain outward elasticity in order to fit between the plurality of projecting teeth of the movable ring hook, and the spacer can be inserted into the middle channel.

2. The handcuffs as described in claim 1, wherein the accommodation chamber also has a plurality of stop blocks, each of which can move along a track to stop each blocking member so that the lock projecting teeth thereof cannot contract inwards, which realizes a reinforced locking state.

3. The handcuffs as described in claim 2, further comprising at least a pair of side holes connecting to the outside are provided on one side of the accommodation chamber corresponding to each stop block so that a thin push rod can be inserted from outside to push the stop blocks and make them slide.

4. The handcuffs as described in claim 2, wherein each locking member has a top projecting part provided on the side opposite to the side having the plurality of lock projecting teeth, each stop block has an abutting part on the side facing the locking member, and each abutting part can abut against each said top projecting part as the stop block moves.

5. The handcuffs as described in claim 2, wherein the elastic member has a V shape and has two branched edge sides to abut against the top side of each locking member, and the other end abuts against the bottom side of the stop block.

6. The handcuffs as described in claim 4, wherein the elastic member has a V shape and has two branched edge sides to abut against the top side of each locking member, and the other end abuts against the bottom side of the stop block.

7. The handcuffs as described in claim 5, wherein a plurality of alignment recessed parts are provided on the bottom side of the stop block, and a bent projecting part that can fit in the alignment recessed part is provided on the side at the corresponding end of the elastic member.

8. The handcuffs as described in claim 6, wherein a plurality of alignment recessed parts are provided on the bottom side of the stop block, and a bent projecting part that can fit in the alignment recessed part is provided on the side at the corresponding end of the elastic member.

9. The handcuffs as described in claim 1 wherein the locking members and the spacer have respective side projecting parts that project outwards and are provided at the end corresponding to the key hole.

10. The handcuffs as described in claim 4, wherein the locking members and the spacer have respective side projecting parts that project outwards and are provided at the end corresponding to the key hole.

11. The handcuffs as described in claim 5, wherein the locking members and the spacer have respective side projecting parts that project outwards and are provided at the end corresponding to the key hole.

12. The handcuffs as described in claim 6, wherein the locking members and the spacer have respective side projecting parts that project outwards and are provided at the end corresponding to the key hole.

13. The handcuffs as described in claim 7, wherein the locking members and the spacer have respective side projecting parts that project outwards and are provided at the end corresponding to the key hole.

14. The handcuffs as described in claim 8, wherein the locking members and the spacer have respective side projecting parts that project outwards and are provided at the end corresponding to the key hole.

15. The handcuffs as described in claim 3, wherein each locking member has a top projecting part provided on the side opposite to the side having the plurality of lock projecting teeth, each stop block has an abutting part on the side facing the locking member, and each abutting part can abut against each said top projecting part as the stop block moves.

16. The handcuffs as described in claim 3 wherein the elastic member has a V shape and has two branched edge sides to abut against the top side of each locking member, and the other end abuts against the bottom side of the stop block

17. The handcuffs as described in claim 2 wherein the locking members and the spacer have respective side projecting parts that project outwards and are provided at the end corresponding to the key hole.

18. The handcuffs as described in claim 3 wherein the locking members and the spacer have respective side projecting parts that project outwards and are provided at the end corresponding to the key hole.
